(19) United States
(12) Patent Application Publication
(10) Pub. No.: US 2009/0243766 A1
(43) Pub. Date: Oct. 1, 2009

(54) CORNER WAVEGUIDE

(76) Inventors: Tetsuya Miyagawa, Nishinomiya-City (JP); Akihiro Hino, Nishinomiya-City (JP)

Correspondence Address: BIRCH STEWART KOLASCH & BIRCH, PO BOX 747, FALLS CHURCH, VA, 22040-0747, US

(21) Appl. No.: 12/415,582

(22) Filed: Mar. 31, 2009

(30) Foreign Application Priority Data
Apr. 1, 2008 (JP) 2008-095267

(51) Int. Cl. H01P 1/02

(52) U.S. Cl. 333/249

(57) ABSTRACT

The disclosure provides a corner waveguide including a first straight waveguide portion for transmitting an electromagnetic wave, a second straight waveguide portion for transmitting an electromagnetic wave to a direction different from the transmitting direction of the electromagnetic wave of the first straight waveguide portion, and a corner waveguide portion connecting the first and second straight waveguide portions. An outside inner wall of the corner waveguide portion has inclined planes inclined at at least three or more different angles with respect to a plane including a longitudinal axis of the waveguide portion.

### CROSS-REFERENCE TO RELATED APPLICATION(S)

This application claims priority under 35 U.S.C. §119 to Japanese Patent Application No. 2008-095267, which is filed on Apr. 1, 2008, the entire disclosure of which is hereby incorporated by reference.

### TECHNICAL FIELD

The present invention relates to a waveguide for transmitting electromagnetic waves, such as microwaves, and particularly to a corner waveguide, which has bend angles to change the travelling direction of the electromagnetic waves transmitting in a straight waveguide.

### BACKGROUND

FIG. 1 shows a conventional U-shaped corner waveguide and FIGS. 2A to 2D are cross-sectional plan views illustrating the shapes of the inner walls of the conventional U-shaped corner waveguide.

The shape of the corner waveguide which is in a round shape (circular bend) shown in FIG. 2A, and the shape of the corner the outside corner of which is cut out or inclined at an angle of 45 degrees (mitered) shown in FIG. 2B, are representative examples of the conventional U-shaped corner waveguide, as disclosed in JP2001-298301A. In the description hereinafter, the corner waveguide shown in FIG. 2A is called a circular bend waveguide and the corner waveguide shown in FIG. 2B is called a mitered corner waveguide.

These corner waveguides are designed to minimize reflection by the curves as much as possible and reflection characteristics are around −30 dB at the E corner where the E (electric field) plane is curved and around −20 dB at the H corner where the H (magnetic field) plane is curved.

FIGS. 2C and 2D show techniques for the corner waveguide to attain lower reflection through broadband compared with the corner waveguide shown in FIG. 2B. FIG. 2C shows the waveguide in which stubs are provided, and FIG. 2D shows the waveguide in which metal posts are provided. Each of these achieves a broader band by providing the stubs or metal posts for matching impedance in the waveguide and lower reflection by suppressing reflection produced when the direction of a guided wave is changed.

A radar apparatus is a usage example of the aforementioned corner waveguides. The corner waveguide is used as a guide wave path between, for example, an oscillator to oscillate microwaves and an antenna to emit the microwaves in the air. As for the antenna in the radar apparatus, it is a condition that it revolves at a high speed of about 30 turns per minute and endures strong wind of 100 m/s. Therefore, it is necessary that an antenna unit in which the corner waveguide is arranged is required to be in a shape with as less resistance as possible, and low reflection characteristics in broadband and being as smaller in shape as possible need to be achieved for the corner waveguide included in the antenna unit.

However, although the circular bend waveguide shown in FIG. 2A has broadband, because favorable reflection characteristics cannot be obtained unless the radius of the circular bend should be large, a small-sized circular bend waveguide cannot obtain the favorable characteristics. As to circular bend waveguides, the outside contour of the corner waveguide determines the radius of the corner or bend, and thus, there are less parameters for adjusting and a smaller degree of design freedom to obtain the favorable characteristics.

The mitered corner waveguide shown in FIG. 2B has a narrow band compared with the circular bend waveguide and does not have good reflection characteristics, and thereafter, it cannot obtain enough characteristics at a level for practical application. Thus, it is common that low reflection characteristics are achieved in broadband by providing the stubs or metal posts in the corner waveguide; however, these configurations require forming projections in the waveguide, resulting in difficulty in manufacturing. In the case that the stubs or metal posts are arranged in the corner waveguide, it is necessary to adjust the position, dimension, number and the like of the stubs or metal posts arranged in the waveguide. There are too many adjusting parameters, which cause a difficulty in the designing.

### SUMMARY

The present invention is made in consideration of the aforementioned situations, and provides a small-sized corner waveguide which easily enables to implement design or manufacturing of the corner waveguide, and can achieve low reflection characteristics.

According to an aspect of the present invention, a corner waveguide is provided, which includes a first straight waveguide portion for transmitting an electromagnetic wave, a second straight waveguide portion for transmitting an electromagnetic wave to a direction different from the transmitting direction of the electromagnetic wave of the first straight waveguide portion, and a corner waveguide portion connecting the first and second straight waveguide portions. An outside inner wall of the corner waveguide portion has inclined planes inclined at at least three or more different angles with respect to a plane including a longitudinal axis of the waveguide portion.

According to another aspect of the present invention, a corner waveguide is provided, which includes a first straight waveguide portion for transmitting an electromagnetic wave, a second straight waveguide portion for transmitting the electromagnetic wave to a direction different from the first straight waveguide portion, and a corner waveguide portion connecting the first and second straight waveguide portions. An outside inner wall of the corner waveguide portion has three or more inclined planes for reflecting the electromagnetic wave transmitting inside the waveguide portion. The inclined plane has an inclined plane area where a phase difference in each reflected wave reflected at the different inclined planes is (2n−1)π (here, n is an integer).

The corner waveguide may be a U-shaped corner waveguide in which the longitudinal axis of the first straight waveguide portion and the longitudinal axis of the second straight waveguide portion are arranged substantially parallel to each other.

The U-shaped corner waveguide may have the inclined planes inclined at angles of 22.5 degrees, 45 degrees, 67.5 degrees, 112.5 degrees, 135 degrees, and 157.5 degrees with respect to a plane including the longitudinal axis of the first or second straight waveguide portion.

The corner waveguide may be an L-shaped corner waveguide in which the longitudinal axis of the first straight waveguide portion and the longitudinal axis of the second straight waveguide portion are arranged substantially perpendicularly to each other.

The L-shaped corner waveguide may have the inclined planes inclined at angles of 22.5 degrees, 45 degrees, and 67.5 degrees with respect to a plane including the longitudinal axis of the first or second waveguide portion.

According to another aspect of the present invention, a corner waveguide is provided, which includes a first straight waveguide portion for transmitting an electromagnetic wave, a second straight waveguide portion for transmitting an electromagnetic wave to a direction different from the transmitting direction of the electromagnetic wave of the first straight waveguide portion, and a corner waveguide portion connecting the first and second straight waveguide portions. An outside inner wall of the corner waveguide portion has a curved plane formed along virtual inclined planes inclined at at least three or more different angles with respect to a plane including a longitudinal axis of the waveguide portion.

### BRIEF DESCRIPTION OF THE DRAWINGS

The present disclosure is illustrated by way of example and not by way of limitation in the figures of the accompanying drawings, in which the like reference numerals indicate like elements and in which:

FIG. 1 is a perspective view showing a conventional corner waveguide;

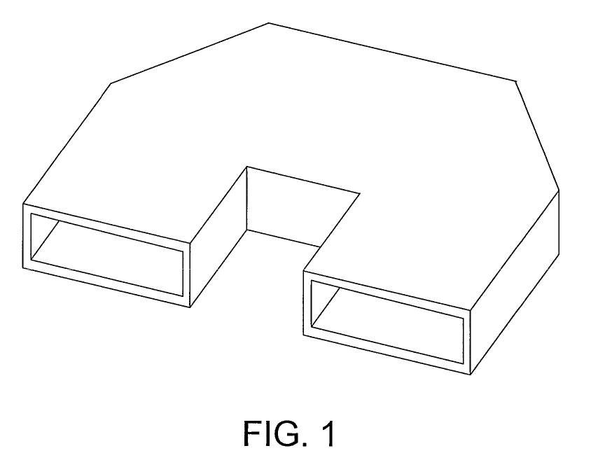

FIGS. 2A to 2D are cross-sectional plan views illustrating shapes of inner walls of conventional corner waveguides;

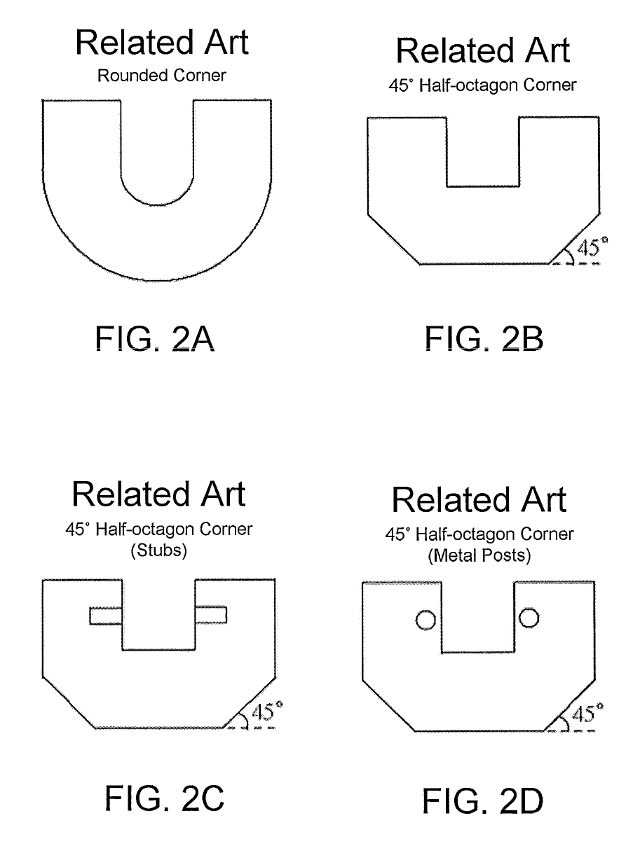

FIGS. 3A and 3B are views illustrating a shape of inner walls of a corner waveguide according to Embodiment 1 of the present invention;

FIG. 4 shows a result of a simulation of reflection characteristics of the corner waveguide of this embodiment and the corner waveguides of related art;

FIGS. 5A to 5C are cross-sectional plan views illustrating shapes of inner wall planes of the corner waveguides used for the simulation; FIG. 5A and FIG. 5B illustrate the conventional art while FIG. 5C is a corner waveguide of Embodiment 1;

FIG. 6 shows a simulation result of reflection characteristics of the corner waveguide of this embodiment and the corner waveguides of related art;

FIGS. 7A to 7C are cross-sectional plan views illustrating shape of inner wall planes of the corner waveguides used for the simulation; FIGS. 7B and 7C are conventional art while FIG. 7A is the corner waveguide of Embodiment 1;

FIGS. 8A and 8B are drawings illustrating a shape of inner walls of a corner waveguide according to Embodiment 2 of the present invention;

FIG. 9 shows a result of a simulation of reflection characteristics of the corner waveguide of this embodiment and the conventional corner waveguide;

FIGS. 10A and 10B show cross-sectional plan views of inner walls of the corner waveguides employed for the simulation; FIG. 10A is conventional art while FIG. 10B is the corner waveguide of Embodiment 2;

FIGS. 11A and 11B are drawings for illustrating a shape of inner walls of a corner waveguide according to Embodiment 3 of the present invention; and

FIG. 12 shows a result of a simulation of reflection characteristics of the corner waveguide of this embodiment and the conventional corner waveguide.

FIGS. 13A-13C are cross-sectional plan views illustrating shapes of inner wall planes of the corner waveguides used for the simulation (FIG. 12). FIG. 13A being conventional art, FIG. 13B being the corner waveguide of Embodiment 1 and FIG. 13C being the corner waveguide of Embodiment 3.

### DETAILED DESCRIPTION OF THE PREFERRED EMBODIMENT

### Embodiment 1

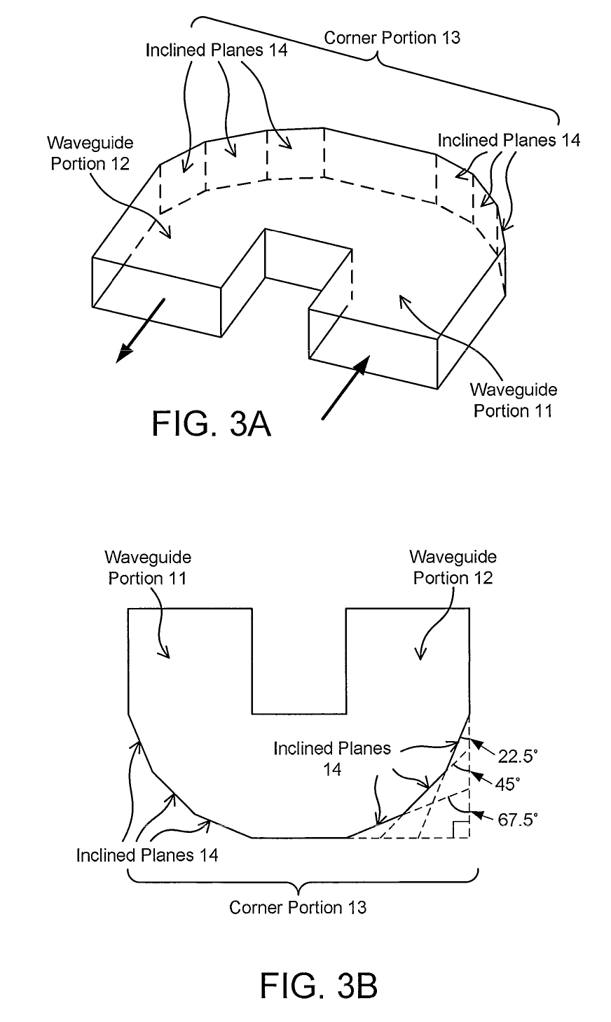

FIGS. 3A and 3B are views illustrating the shape of the inner walls of the corner waveguide according to Embodiment 1 of the present invention, FIG. 3A is a perspective view of the planes of the inner walls of the corner waveguide of this embodiment, and FIG. 3B is a cross-sectional plan view of the planes of the inner walls of the corner waveguide of this embodiment.

The corner waveguide in this embodiment is a U-shaped corner waveguide (tube) which has a straight waveguide portion 11 (first straight waveguide portion), a straight waveguide portion 12 (second straight waveguide portion) positioned substantially paralleled to the straight waveguide portion 11, and a corner waveguide portion 13 connecting the first and second straight waveguide portions. Note that the corner waveguide may, but not limited to, include the two straight waveguide portions, and may be coupled to the separated straight waveguides.

Here, a tube axis of the straight waveguide portion 11 and a tube axis of the straight waveguide portion 12 are positioned substantially paralleled to each other and, thus, the transmission direction of electromagnetic waves transmitting inside the straight waveguide portion 11 and the transmission direction of electromagnetic waves transmitting inside the straight waveguide portion 12 are different by substantially 180 degrees.

The straight waveguide portion 11 and straight waveguide portion 12 are metal tubes with a rectangular cross-section, which become guide wave paths to transmit the electromagnetic waves. The cross-section of the straight waveguide portions 11 and 12 may be in other shapes, such as a circular shape, an octagonal shape, etc. The corner waveguide portion 13 provided between the straight waveguide portion 11 and straight waveguide portion 12 changes the direction of the guide wave which transmits in the straight waveguide portion 11, and plays a role to transmit the electromagnetic waves from the straight waveguide portion 11 to the straight waveguide portion 12, or vice versa. The corner waveguide portion 13 includes the H corner, which changes the direction of the guide wave at the H plane, and the corner E, which changes the direction of the guide wave at the E plane. Both of the corners can be applied to the present invention. An example of an H corner waveguide that changes the direction of the guide wave at the H plane will be described here, without limiting to the H corner waveguide. For the sake of simplicity, the corner waveguide is arranged horizontally herein; however, the orientation of the corner waveguide is not limited to this and may be determined depending on the orientation and shape of waveguide members connected to the first and second straight waveguide portions. The corner waveguide portion may be separately or integrally provided with the first and/or second straight waveguide portion.

The corner waveguide portion 13 is also constructed of a metal tube, same as the straight waveguide portions 11 and 12 and the outside inner walls of the corner waveguide portion 13 have inclined planes 14, which incline at angles of at least three different degrees or more with respect to the planes which include the tube axis of the straight waveguide portion 11 or straight waveguide portion 12. The inclined planes here mean planes which cross at a certain inclination to the plane which includes a tube axis, and a plane which crosses perpendicularly to the plane including the tube axis of the straight waveguide portion 11 or straight waveguide portion 12 is excluded. The U-shaped corner waveguide of this embodiment has, as shown in FIG. 3B, outside inner walls which have inclined planes 14 that incline axisymmetrically at each angle of 22.5 degrees, 45 degrees, and 67.5 degrees with respect to the planes including the tube axis of the straight waveguide portion (here, the planes are parallel to the outside inner walls of the straight waveguide portions). Thus, the inclined planes 14 are formed at angles of 22.5 degrees, 45 degrees, 67.5 degrees, 112.5 degrees, 135 degrees, and 157.5 degrees with respect to the outside inner wall of the straight waveguide portion 11. The shape of the inside inner walls of the corner waveguide portion 13 are not particularly limited to this example.

Next, the design method of the inclined planes 14 will be described. Firstly, with respect to the U-shaped corner waveguide having corners of 90 degrees at the left and right sides, the inclined plane 14 on the left side having an angle of 45 degrees with respect to the plane including the tube axis of the straight waveguide portion 11, and the inclined plane 14 on the right side having an angle of 45 degrees with respect to the plane including the tube axis of the straight waveguide portion 12 are provided. At this time, by adjusting the position of the inclined plane 14 having an angle of 45 degrees, band characteristics and reflection characteristics of the transmission waves transmitted in the corner waveguide are optimized. Because the design parameter is one, this design can be relatively easily implemented.

In this embodiment, a straight portion is provided between the pair of inclined planes 14, which is located between the two straight waveguide portions 11 and 12; how ever, the straight portion may be omitted to couple the inclined plane pair together if appropriate from the designing limitations.

Referring back to FIGS. 3A and 3B, the remaining two inclined planes 14 having angles of 22.5 degrees and 67.5 degrees with respect to the planes including the tube axes of the straight waveguide portion 11 and straight waveguide portion 12 are provided. At this time, by adjusting the position of the inclined planes 14 having angles of 22.5 degrees and 67.5 degrees, band characteristics and reflection characteristics of the transmission waves transmitted in the corner waveguide are optimized. Because the design parameter is one for the respective inclined planes, this design can be relatively easily implemented.

The inclined plane 14 having an angle of 67.5 degrees with respect to the plane including the tube axis of the straight waveguide portion 11 or straight waveguide portion 12 becomes an inclined plane having an angle of 22.5 degrees with respect to the plane crossing perpendicularly to the plane including the tube axis of the straight waveguide portion 11 or straight waveguide portion 12. Therefore, when the inclined planes 14 having angles of 22.5 degrees and 67.5 degrees are formed axisymmetrically, these can be one design parameter. Thus, the corner waveguide of this embodiment can match with the two parameters of the inclined plane having an angle of 45 degrees and the inclined plane having an angle of 22.5 degrees (or 67.5 degrees).

Generally, in the case in which the corner waveguides are designed using stubs or metal posts, the degree of positional or dimensional freedom of the stubs or metal posts is large, which makes optimization difficult. On the contrary, in this embodiment, matching can be implemented by the two design parameters as described above, resulting in extremely easy designing of the corner waveguide compared with designing corner waveguides by using stubs or metal posts. The angles with respect to the planes including the tube axis of the straight waveguide portion are not limited to 22.5 degrees, 45 degrees, or 67.5 degrees and other angles can implement the matching.

Next, the operation of the corner waveguide of this embodiment will be described. As shown by arrows in FIG. 3A, an electromagnetic field inputted from the straight waveguide portion 11 is transmitted in the straight waveguide portion 11 and a part of the electromagnetic field reflects at the corner waveguide portion 13. The reflected wave causes deterioration in input/output characteristics of signals.

The corner waveguide of this embodiment provides the inclined planes 14 at a plurality of different angles on the outside inner walls of the corner waveguide portion 13, and actively produces areas where the phase difference in each reflected wave reflected at the different inclined planes 14 is (2n−1)π (here, n is an integer). At this time, the wavelength of each reflected wave reflected at the inclined planes 14 has a relation, λ/4+λ/2×m (here, λ is a wavelength of electromagnetic wave transmitting in the waveguide, and m is an integer), and the reflected waves negate each other resulting in impossible existence of the reflected waves in the waveguide. This has achieved this embodiment with favorable input/output characteristics.

In the corner waveguide of this embodiment, the reflection of the electromagnetic wave is produced at the inclined planes 14 having certain angles, and thus, the reflected wave satisfies matching conditions not only at specified frequencies, but also at certain frequency ranges which has some width. Thereby, the corner waveguide of this embodiment achieves lower reflection as well as a broader band at the same time.

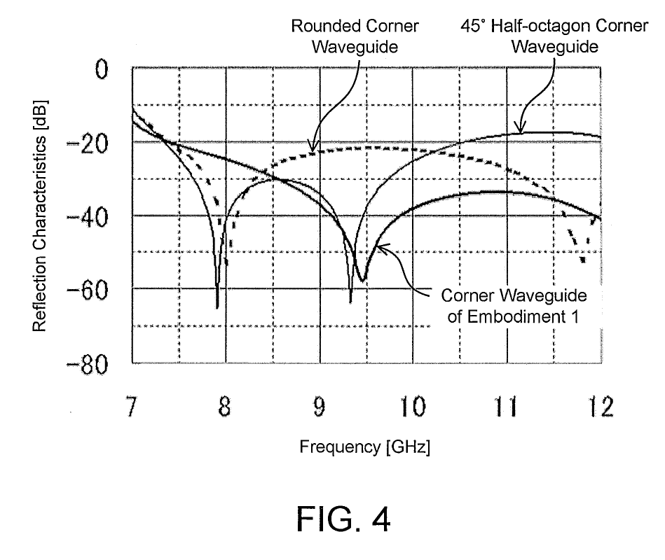

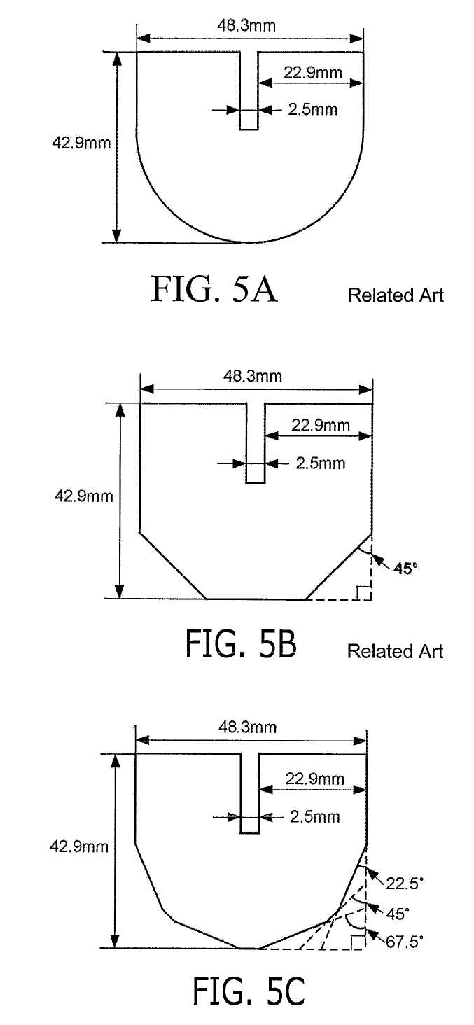

Next, a result of a simulation conducted by using the corner waveguide of this embodiment will be shown. FIG. 4 shows the result of a simulation of reflection characteristics of the corner waveguide of this embodiment and the corner waveguides of related art. FIGS. 5A to 5C are cross-sectional plan views illustrating shapes of inner wall planes of the corner waveguides used for the simulation.

The corner waveguides employed for the simulation have rectangular-cross-section straight waveguide portions 11 and 12 with a length of 22.9 mm on the long sides and 10.2 mm on the short sides (not illustrated in the figures), which are connected by the corner waveguide portion 13. The space between the inside inner walls of the straight waveguide portion 11 and straight waveguide portion 12 positioned parallely is 2.5 mm. As described above, this space may not be needed to implement the configuration illustrated in this embodiment.

The comparison was implemented, as shown in FIGS. 5A to 5C, between the circular bend waveguide in which the outside inner wall of the corner waveguide portion 13 is round (FIG. 5A), the mitered corner waveguide in which the outside inner wall of the corner waveguide portion 13 is the corner having an angle of 45 degrees (FIG. 5B), and the corner waveguide of this embodiment formed with inclined planes having angles of 22.5 degrees, 45 degrees, and 67.5 degrees with respect to the plane including the tube axis of the straight waveguide portion (FIG. 5C). Each of them is designed so that the center frequency of the corner waveguide is 9.41 GHz.

In the case of the circular bend waveguide shown in FIG. 5A, the length of the long side of the straight waveguide portions 11 and 12 and the space between the straight waveguide portions 11 and 12 determine the radius of the circular bend. Therefore, if the straight waveguide portions 11 and 12 downsize by narrowing their space, the characteristics is worsen due to the smaller diameter of the circular bend. As is obvious from FIG. 4, compared with the corner waveguide of this embodiment, it has worse reflection characteristics through broadband.

Because the spaces between the straight waveguide portions 11 and 12 are fixed to be 2.5 mm, the radius of the circular bend is decided, and parameter for adjusting at the time of designing the circular bend does not exist. Hence, the center frequency of the corner waveguide having the circular bend becomes around 8 GHz, resulting in that the center frequency cannot be adjusted to be around 9.41 GHz, which is the desired frequency, like the corner waveguide of this embodiment does.

On the contrary, in the case of the mitered corner waveguide shown in FIG. 5B, the position where cutouts at angles of 45 degrees are formed can be adjustable. Thereafter, the center frequency of the corner waveguide can be around 9.41 GHz, which is the desired frequency. The mitered corner waveguide has, however, a frequency band of about 300 MHz at −40 dB, which is exceedingly narrow, and may have practical issues. The corner waveguide of this embodiment in comparison can have the center frequency of the corner waveguide of around 9.41 GHz, has the reflection characteristics of 800 MHz or more at −40 dB, and has more than twice as the broader band as the mitered corner.

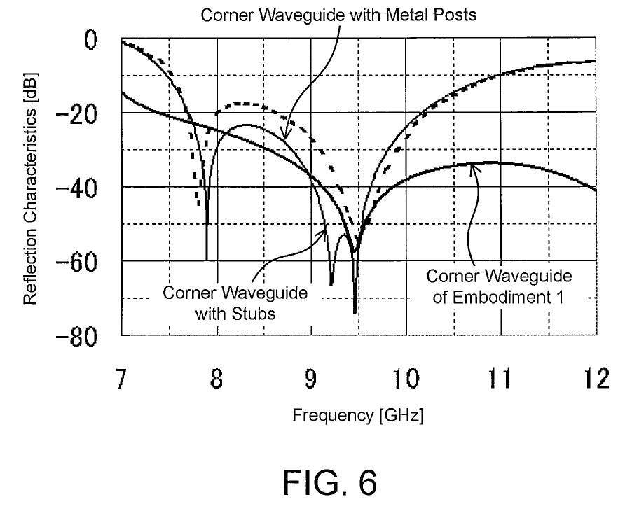

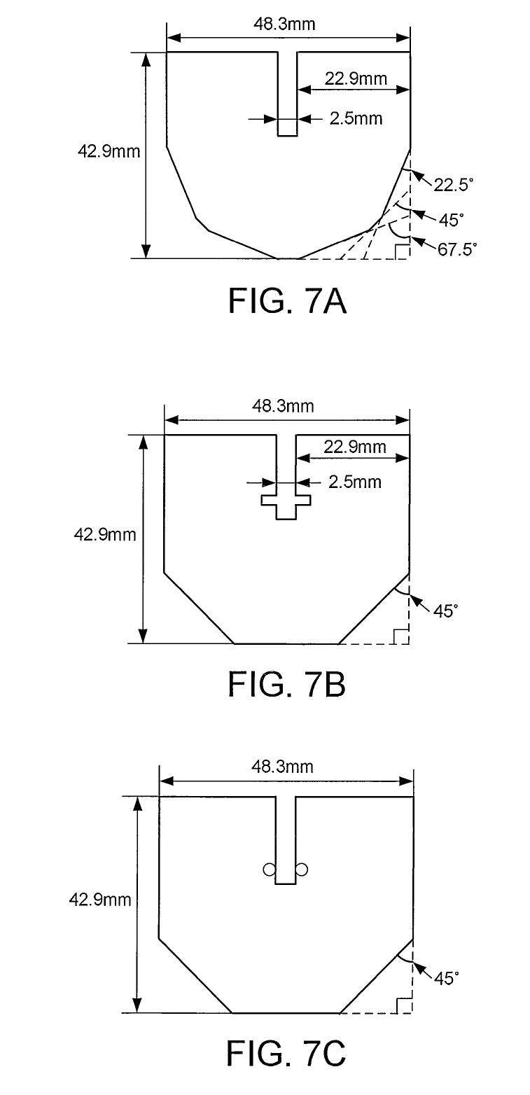

Then, comparative results between the corner waveguide of this embodiment and the mitered corner waveguide provided with stubs or metal posts will be explained. FIG. 6 shows a simulation result of the reflection characteristics of the corner waveguide of this embodiment and the corner waveguides of related art. FIGS. 7A to 7C are cross-sectional plan views illustrating the inner walls of the corner waveguides used for the simulation.

As shown in FIGS. 7A to 7C, any corner waveguides used for the simulation have rectangular-cross-section straight waveguide portions 11 and 12 with a length of 22.9 mm on the long sides and 10.2 mm on the short sides (not illustrated in the figures), which are connected by the corner waveguide portion 13, and the space between the inner walls of the straight waveguide portion 11 and straight waveguide portion 12 positioned parallely is 2.5 mm. FIG. 7A shows the corner waveguide of this embodiment. FIG. 7B illustrates the mitered corner waveguide shown in FIG. 5B additionally provided with stubs in the corner waveguide portion, and FIG. 7C illustrates the mitered corner waveguide shown in FIG. 5B additionally provided with metal posts in the corner waveguide portion, so as to adjust to achieve low reflection characteristics throughout broadband.

As a result of the simulation, as shown in FIG. 6, in a range of the reflection characteristics at −30 dB and −40 dB, the corner waveguide of this embodiment has the broader band than the conventional corner waveguides provided with the stubs or metal posts, which proves that it can obtain a similar or more effect when compared with the conventional corner waveguide provided with the stubs or metal posts. The conventional corner waveguide provided with the stubs or metal posts, as evidenced by configurations in FIGS. 7B and 7C, cannot be manufactured by molding at a low cost, since it is necessary for projections to be arranged in the inner walls of the waveguides.

As described above, the corner waveguide of this embodiment can be superior to the conventional corner waveguide provided with the stubs or metal posts in terms of the electrical properties and ease of processing. Even when the straight waveguide portion 11 and straight waveguide portion 12 are positioned proximally and electromagnetic waves which transmit into the straight waveguide portion 11 and electromagnetic waves which transmit into the straight waveguide portion 12 interfere each other in the corner waveguide portion 13, the corner waveguide of this embodiment can obtain low reflection characteristics throughout broadband and can achieve minimization of the corner waveguide.

### Embodiment 2

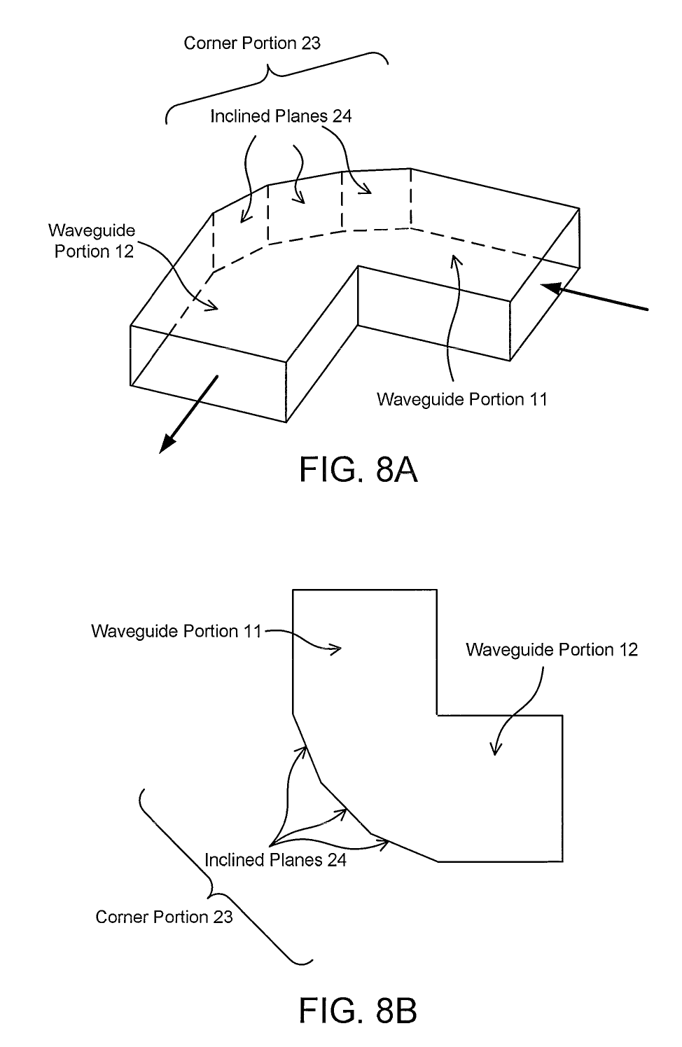

Next, a corner waveguide 23 in Embodiment 2 of the present invention will be described. FIGS. 8A and 8B are drawings illustrating a shape of the inner walls of the corner waveguide of this embodiment. FIG. 8A shows a perspective view of the plane of the inner walls of the corner waveguide, and FIG. 8B is a cross-sectional plan view illustrating the plane of the inner walls of the corner waveguide of this embodiment.

The corner waveguide of this embodiment is an L-shaped corner waveguide (tube), which has a straight waveguide portion 11 (first straight waveguide portion), a straight waveguide portion 12 (second straight waveguide portion), and a corner waveguide portion 23. As described in the previous embodiment, the straight waveguide portions may be omitted. Here, a tube axis of the straight waveguide portion 11 and a tube axis of the straight waveguide portion 12 are arranged substantially perpendicularly. The transmission direction of the electromagnetic waves which transmit in the straight waveguide portion 11 and the transmission direction of the electromagnetic waves which transmit in the straight waveguide portion 12 differ at an angle of approximately 90 degrees. As for the same elements as those of the U-shaped corner waveguide aforementioned in Embodiment 1, the same reference numerals are denoted and the description is omitted here.

The corner waveguide portion 23 plays a role to change the direction of the guide wave which transmits in the straight waveguide portion 11 and to transmit the electromagnetic waves from the straight waveguide portion 11 to the straight waveguide portion 12. The corner waveguide portion 23 is constructed of a metal tube which is the same as the straight waveguide portions 11 and 12. The outside inner wall of the corner waveguide portion 13 has inclined planes 24 inclined at at least three or more different angles with respect to a plane including a tube axis of the straight waveguide portion 11 or straight waveguide portion 12. The inclined plane here means a plane which crosses at a certain inclination with respect to the plane which includes a tube axis, and a plane which crosses perpendicularly to the plane including the tube axis of the straight waveguide portion 11 or straight waveguide portion 12 is excluded. In the L-shaped corner waveguide of this embodiment, as shown in FIG. 8B, the outside inner wall of the corner waveguide has inclined planes 24 inclined at angles of 22.5 degrees, 45 degrees, and 67.5 degrees with respect to a plane including the tube axis of the straight waveguide portion (this plane is parallel to the outside inner walls of the straight waveguide portion). The shape of inside inner walls of the corner waveguide portion 13 is not particularly limited and may be a corner at an angle of 90 degrees as shown or be other shapes.

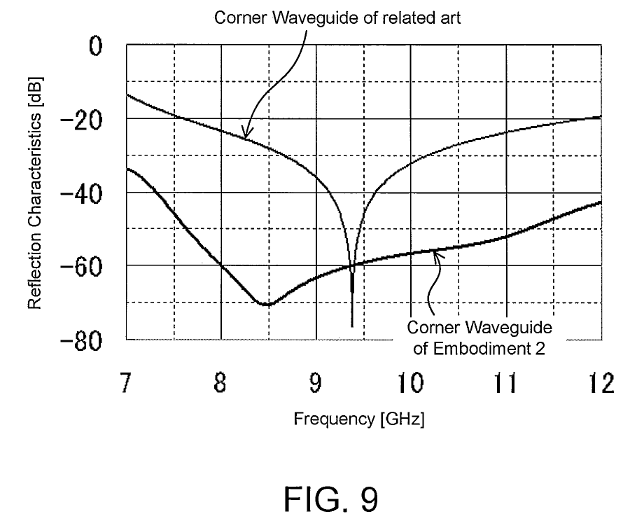

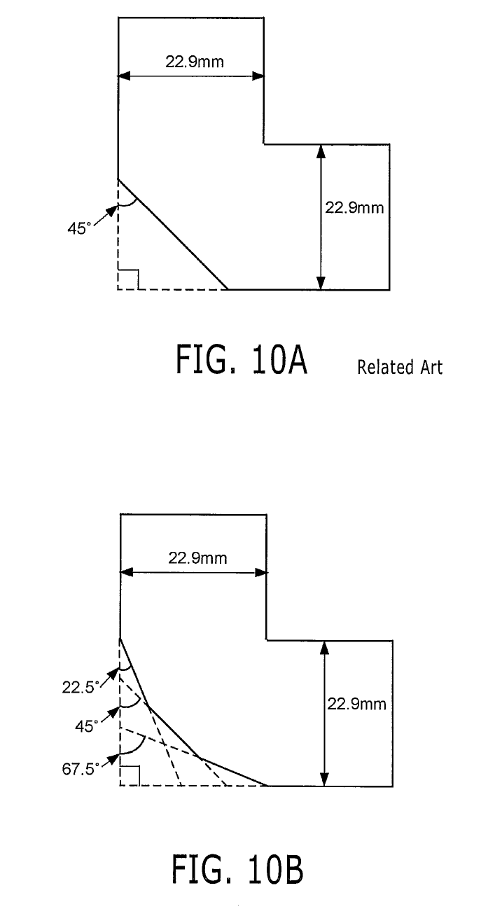

FIG. 9 shows a result of the simulation of the reflection characteristics of the corner waveguide of this embodiment and the conventional corner waveguide. FIGS. 10A and 10B show cross-sectional plan views of the inner walls of the corner waveguides employed for the simulation. Both of the corner waveguides employed for the simulation have rectangular-cross-section straight waveguide portions 11 and 12 with a length of 22.9 mm on the long sides and 10.2 mm on the short sides (not illustrated in the figures), which are connected by the corner waveguide portion 13. The comparison was implemented with, as shown in FIGS. 10A and 10B, the conventional corner waveguide in which the outside inner wall of the corner waveguide portion 13 is a 45-degree cut-out corner (FIG. 10A), and the corner waveguide of this embodiment, which is formed with inclined planes inclined at angles of 22.5 degrees, 45 degrees, and 67.5 degrees with respect to the plane including the tube axis of the straight waveguide portion (FIG. 10B). Each of them is designed so that the center frequency of the corner waveguides becomes 9.41 GHz.

The 45-degree cut-out corner waveguide shown in FIG. 10A has the frequency band of about 400 MHz at −40 dB, which is narrow. On the contrary, the corner waveguide of this embodiment shown in FIG. 10B has the reflection characteristics, which has a frequency band of 4 GHz or more at −40 dB, which is ten times broader in band than the 45-degree cut-out corner waveguide.

As described above, the inclined planes 24 inclined at at least more than three different angles with respect to the plane including the tube axis of the straight waveguide portion 11 or straight waveguide portion 12 being arranged in the L-shaped corner waveguide allow to achieve low reflection characteristics throughout broadband similar to the U-shaped corner waveguide. This is not limited to the L-shaped or U-shaped corner waveguide, and other corner waveguides in other shapes than those illustrated in the embodiments can also attain the effectiveness in a similar way.

### Embodiment 3

In a corner waveguide in Embodiment 3 of the present invention, the outside inner walls of the corner waveguide portion 13 of the previous embodiments are replaced with the inner walls having a plurality of curved planes formed along the plurality of inclined planes of the previous embodiments.

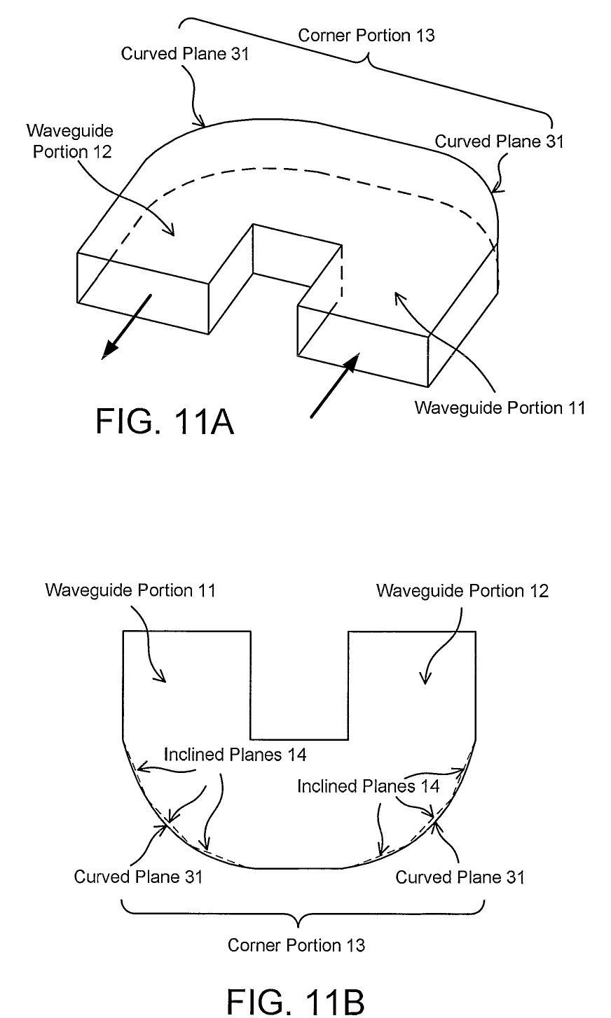

FIGS. 11A and 11B are drawings for illustrating a shape of the inner walls of the corner waveguide of this embodiment. FIG. 11A is a perspective view of planes of the inner walls of the corner waveguide of this embodiment, and FIG. 11B is a cross-sectional plan view of the planes of the inner walls of the corner waveguide of this embodiment. The inclined planes 14 represented in dotted lines in FIG. 11B correspond to the inclined planes described in the previous embodiments.

As shown in FIG. 11B, the shape of the plane of the outside inner walls of the U-shaped corner waveguide in this embodiment is the curved planes 31 formed along a plurality of inclined planes 14. Actually, the inclined planes 14 do not exist in this embodiment and they are merely virtual lines to illustrate how each of the curved planes 31 follows the inclined planes 14. As to the same elements as that of the U-shaped corner waveguide aforementioned in Embodiment 1, the same reference numerals are denoted and the description is omitted here.

As described above, the curved planes 31 shown in FIG. 11B are formed by connecting the intersecting lines of the adjacent inclined planes by a curved plane and allow low reflection characteristics throughout broadband the same case as the case in which the outside inner walls of the corner waveguide are formed by inclined planes. Besides the curved plane formed by connecting the intersecting lines by the curved plane, the curved plane 31 may be any other curved plane formed substantially along the inclined planes (except in which the section of them becomes an arc of a perfect circle), and designing with a certain flexibility is possible. Each of the curved planes 31 may be entirely a continuous curved plane with partially varying radius of curvature, or consist of a plurality of curved planes with different radius of curvatures.

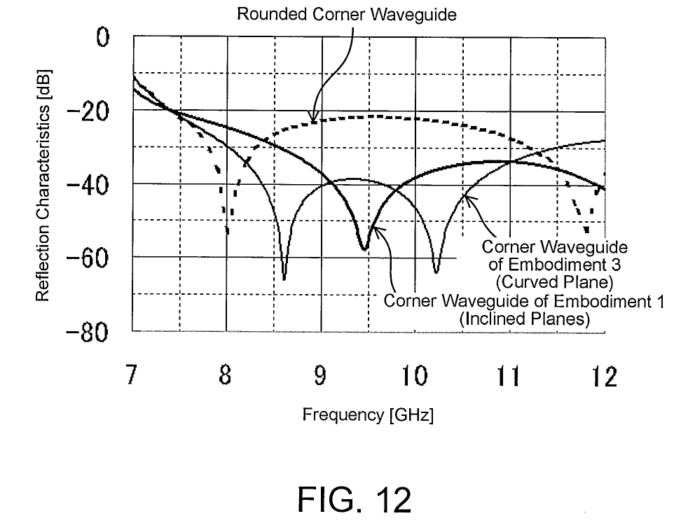

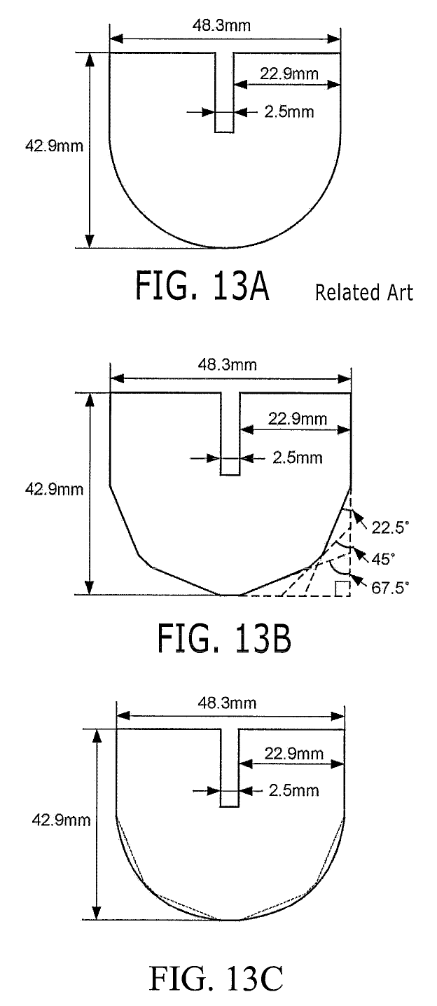

FIG. 12 shows a result of the simulation of the reflection characteristics, which the corner waveguides of Embodiment 1 and this embodiment and the conventional corner waveguide have. FIGS. 13A to 13C are cross-sectional plan views illustrating shapes of the planes of the inner walls of the corner waveguides employed for the simulation.

Any corner waveguides employed for the simulation have a rectangular cross-section waveguide portion 11 and a rectangular cross-section waveguide portion 12 with a length of 22.9 mm on the long sides and 10.2 mm on the short sides (not illustrated in the figures), which are connected by the corner waveguide portion. The comparison was implemented, as shown in FIGS. 13A to 13C, between the conventional corner waveguide in which the outside inner walls of the corner waveguide portion is the circular bend (FIG. 13A), the corner waveguide of Embodiment 1 in which the inclined planes are formed at angles of 22.5 degrees, 45 degrees, and 67.5 degrees with respect to the plane including the tube axis of the straight waveguide portion (FIG. 13B), and the corner waveguide of this embodiment in which the intersecting lines of the adjacent inclined planes are connected by the curved plane (FIG. 13C). Each of them is designed so that the corner waveguide has the center frequency of 9.41 GHz.

As shown in FIG. 12, the corner waveguide (with inclined planes) of Embodiment 1 and the corner waveguide (with curved planes) of Embodiment 3 have the frequency broadband of at least 2 GHz or more at −30 dB, and can achieve the low reflection characteristics throughout broadband. In contrast, the conventional circular bend waveguide generally has the worse reflection characteristics, which indicates a plus of about 20 dB compared with the present invention.

As described above, even when the outside inner walls of the corner waveguide portion 13 are replaced from the inclined planes 14 to the curved plane 31 formed along the virtual inclined planes 14, substantially approximately the same effectiveness as the outside inner walls of the corner waveguide portion 13 can be attained and the low reflection characteristics through broadband can be achieved compared with the conventional corner waveguides.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A corner waveguide, comprising:
a first straight waveguide portion for transmitting an electromagnetic wave;
a second straight waveguide portion for transmitting an electromagnetic wave to a direction different from the transmitting direction of the electromagnetic wave of the first straight waveguide portion; and
a corner waveguide portion connecting the first and second straight waveguide portions, an outside inner wall of the corner waveguide portion having inclined planes inclined at at least three or more different angles with respect to a plane including a longitudinal axis of the waveguide portion.

2. A corner waveguide, comprising:
a first straight waveguide portion for transmitting an electromagnetic wave;
a second straight waveguide portion for transmitting the electromagnetic wave to a direction different from the first straight waveguide portion; and
a corner waveguide portion connecting the first and second straight waveguide portions, an outside inner wall of the corner waveguide portion having three or more inclined planes for reflecting the electromagnetic wave transmitting inside the waveguide portion, and the inclined plane having an inclined plane area where a phase difference in each reflected wave reflected at the different inclined planes is (2n−1)π (here, n is an integer).

3. The corner waveguide of claim 1, wherein the corner waveguide is a U-shaped corner waveguide in which the longitudinal axis of the first straight waveguide portion and the longitudinal axis of the second straight waveguide portion are arranged substantially parallel to each other.

4. The corner waveguide of claim 3, wherein the U-shaped corner waveguide has the inclined planes inclined at angles of 22.5 degrees, 45 degrees, 67.5 degrees, 112.5 degrees, 135 degrees, and 157.5 degrees with respect to a plane including the longitudinal axis of the first or second straight waveguide portion.

5. The corner waveguide of claim 1, wherein the corner waveguide is an L-shaped corner waveguide in which the longitudinal axis of the first straight waveguide portion and the longitudinal axis of the second straight waveguide portion are arranged substantially perpendicularly to each other.

6. The corner waveguide of claim 6, wherein the L-shaped corner waveguide has the inclined planes inclined at angles of 22.5 degrees, 45 degrees, and 67.5 degrees with respect to a plane including the longitudinal axis of the first or second waveguide portion.

7. A corner waveguide, comprising:
a first straight waveguide portion for transmitting an electromagnetic wave;
a second straight waveguide portion for transmitting an electromagnetic wave to a direction different from the transmitting direction of the electromagnetic wave of the first straight waveguide portion; and
a corner waveguide portion connecting the first and second straight waveguide portions, an outside inner wall of the corner waveguide portion having a curved plane formed along virtual inclined planes inclined at at least three or more different angles with respect to a plane including a longitudinal axis of the waveguide portion.
